(19) United States
(12) Patent Application Publication
(10) Pub. No.: US 2013/0141334 A1
(43) Pub. Date: Jun. 6, 2013

(54) SYSTEM AND METHOD FOR SWITCHING MOUSE OPERATION MODE

(71) Applicant: CHUN-XIAO WU, Shenzhen City (CN)

(72) Inventor: CHUN-XIAO WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/592,420

(22) Filed: Aug. 23, 2012

(30) Foreign Application Priority Data
Dec. 5, 2011 (CN) 201110398327.5

(51) Int. Cl. G06F 3/033

(52) U.S. Cl. 345/163

(57) ABSTRACT

A system for switching a computer mouse operation mode includes a mouse and a computer, wherein the mouse comprises a first button, a second button, a control unit, and a delivery unit. The control unit determines whether a pressing time of a button reaches a predetermined time, and sets the value of a flag to different values according the pressed button. The computer running an operation system comprises a receiving unit configured to receive the flag output from the delivery unit. The drive unit sets the mouse operation mode according the value of the flag.

### BACKGROUND

1. Technical Field

The present disclosure generally relates to a system and method for switching a mouse operation mode, and particularly to a system and method for switching the mouse operation mode between a right-hand mode and a left-hand mode.

2. Description of Related Art

A computer mouse as an input device of a computer generally has two operation modes: a right-hand mode and a left-handed mode. People usually use the right hand to operate the mouse, thus the right-hand mode is a default operation mode of the computer mouse. A common method to switch the mouse between the left-hand mode and the right-hand mode is by software such as the control panel of the operating system. However, left-hand people or people who need to shift the operation mode frequently, it is inconvenient and troublesome.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a system for switching the operation mode of a mouse of the present disclosure.

FIG. 2 is a flow chart of an embodiment of a method for switching the operation mode of a mouse of the present disclosure.

### DETAILED DESCRIPTION

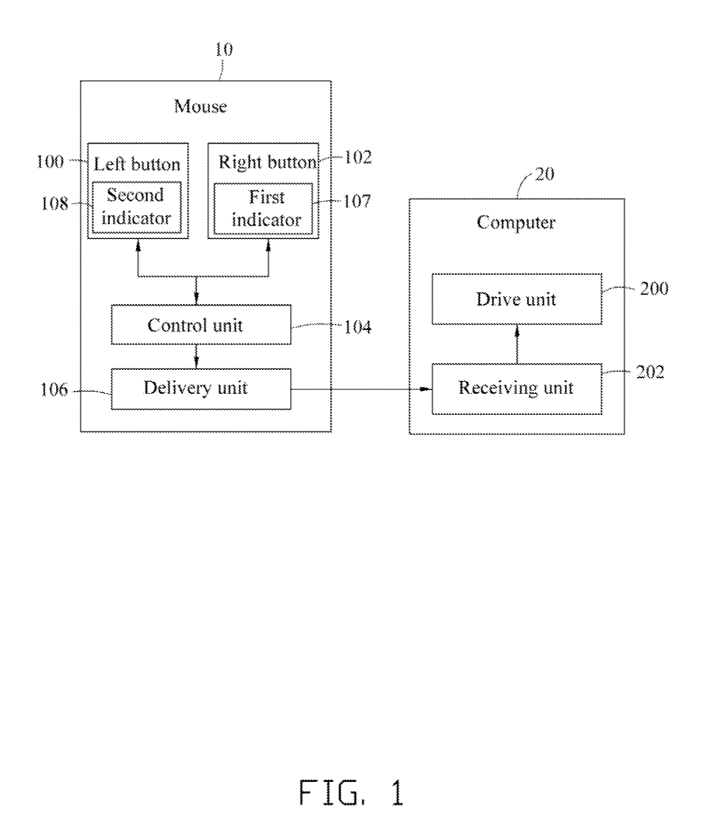

FIG. 1 illustrates an embodiment of a system for switching the operation mode of a mouse of the present disclosure. The system includes a computer 20 and a mouse 10 coupled to the computer 20 in wired or wireless manner. The mouse 10 includes a left button 100, a right button 102, a control unit 104, a delivery unit 106, a first indicator 107, and a second indicator 108. The first indicator 107 and the second indicator 108 are mounted on a top surface of the mouse 10. The first indicator 107 is in a lit state when a current operation mode of the mouse 10 is the right-hand mode, and the second indicator 108 is in a lit state when the current operation mode of the mouse is the left-hand mode. In the illustrated embodiment, the first indicator 107 and the second indicator 108 are light emitting diodes (LEDs). The computer 20 includes a receiving unit 202 and a drive unit 200. The drive unit 200 is configured to set the mouse operation mode in the computer 20.

The control unit 104 stores a flag representing the current mouse operation mode, and determines whether a pressing time of the right button 102 or the left button 100 reaches a predetermined time. If the pressing time of the right button 102 or the left button 100 reaches the predetermined time, the control unit 104 sets a value of the flag according to the pressing of the button. The control unit 104 transmits the flag to the delivery unit 106, and turns the corresponding indicator on. For instance, if the pressing time of the left button 100 reaches the predetermined time, the control unit 104 sets the value of the flag to “0”, and turns the second indicator 108 on and the first indicator 107 off, thereby the current mode of the mouse 10 is the left-hand mode. If the pressing time of the right button 102 reaches the predetermined time, the control unit 104 changes the value of the flag to “1”, and turns the first indicator 107 on and the second indicator 108 off, thereby the current mode of the mouse 10 is the right-hand mode.

Usually, the right-hand mode is a default operation mode of the computer mouse, the control unit 104 turns the first indicator 107 on and the second indicator 108 off, so as to indicate that the current mouse operation mode is the right-hand mode.

If the user is left handed and wants the mouse 10 configured for left-handed mode, the left button 100 is pressed. When the pressing time of the left button 100 reaches the predetermined time, the control unit 104 sets the value of the flag to “0”, and then transmits the flag to the delivery unit 106. In the meanwhile, the control unit 104 turns the first indicator 107 off and the second indicator 108 on, thereby indicating that the current mouse operation mode is the left-hand mode. The delivery unit 106 delivers the flag to the receiving unit 202 of the computer 20. The receiving unit 202 sends the flag to the drive unit 200, and the drive unit 200 sets the mouse operation mode to the left-hand mode.

If the mouse operation mode is changed back to the right-hand mode, the right button 102 is pressed. When the pressing time of the right button 102 reaches the predetermined time, the control unit 104 sets the value of the flag to “1”. In the meantime, the control unit 104 turns the first indicator 107 on and the second indicator 108 off, thereby indicating that the current mouse operation mode is the right-hand mode. The delivery unit 106 delivers the flag to the receiving unit 202 of the computer 20. The receiving unit 202 sends the flag to the drive unit 200, and the drive unit 200 sets the mouse operation mode to the right-hand mode according to the value of the flag.

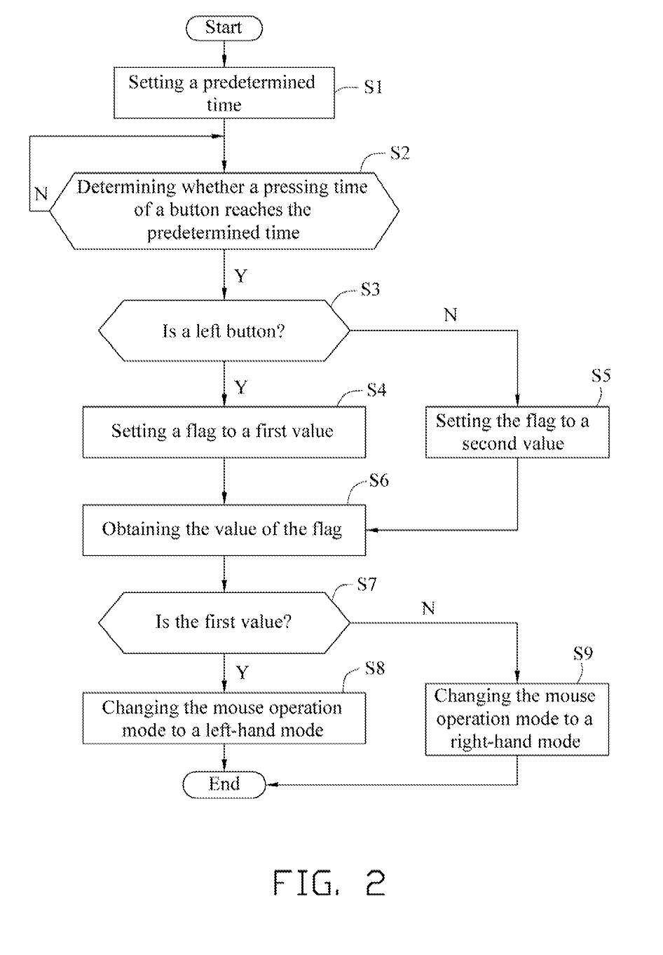

FIG. 2 illustrates an embodiment of a method of switching the operation mode of a mouse of the present disclosure. The method of switching the operation mode of a mouse includes steps as follow.

In step S1, setting a predetermined time.

In step S2, determining whether the pressing time of a button reaches the predetermined time. If the pressing time of the button reaches the predetermined time, the process goes to step S3, otherwise, the step S2 is repeated.

In step S3, determining whether the pressed button is the left button 100 or the right button 102 by the control unit 104. If the pressed button is the left button, the process goes to step S4, otherwise, the process goes to step S5.

In step S4, setting the flag to a first value by the control unit 104.

In step S5, setting the flag to a second value by the control unit 104.

In step S6, obtaining the value of the flag by the drive unit 200.

In step S7, determining whether the value of the flag is the first value by the drive unit 200. If the value of the flag is the first value, the process goes to step S8, otherwise, the process goes to step S9.

In step S8, changing the mouse operation mode to the left-hand mode by the drive unit 200.

In step S9, changing the mouse operation mode to the right-hand mode by the drive unit 200.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A system for switching a computer mouse operation mode, the system comprising:
a mouse, comprising:
a first button;
a second button;
a control unit determining whether a pressing time of the first button or the second button reaches a predetermined time and which one of the first button and the second button is pressed, when the pressing time of the first button or the second button reaches a predetermined time, the control unit sets a value of a flag according to the pressed button; and
a delivery unit transmitting the flag; and
a computer running an operation system, comprising:
a receiving unit receiving the flag outputted from the delivery unit; and
a drive unit setting the mouse operation mode of the computer according to the value of the flag.

2. The system of claim 1, wherein the control unit sets the value of the flag to a first value upon a condition that the pressing time of the first button reaches the predetermined time, and sets the value of the flag to a second value upon a condition that the pressing time of the second button reaches the predetermined time.

3. The system of claim 1, wherein the drive unit sets the mouse operation mode to a left-hand mode when the value of the flag is the first value, and sets the mouse operation mode to a right-hand mode when the value of the flag is the second value.

4. The system of claim 1, further comprising:
a first indicator; and
a second indicator;
wherein the control unit turns the first indicator on and the second indicator off upon a condition that the pressing time of the first button reaches the predetermined time, and turns the first indicator off and the second indicator on upon a condition that the pressing time of the second button reaches the predetermined time.

5. The system of claim 4, wherein the first indicator and the second indicator are light-emitting diodes.

6. A method of switching a mouse operation mode, the method comprising:
determining whether a pressing time of a first button or a second button reaches a predetermined time;
determining whether the pressed button is the first button;
setting a flag to a first value when the pressed button is the first button;
setting the flag to a second value when the pressed button is not the first button; and
setting the mouse operation mode of a computer according to the value of the flag.

7. The method of claim 6, wherein the step of setting the mouse operation mode further comprising:
setting the mouse operation mode to a left-hand mode in response to the flag being the first value;
setting the mouse operation mode to a right-hand mode in response to the flag being the second value.

8. The method of claim 6, further comprising:
turning a first indicator on and a second indicator off upon a condition that the pressed time of the first button reaches the predetermined time; and
turning the first indicator off and the second indicator on upon a condition that the pressed time of the second button reaches the predetermined time.

9. The method of claim 8, wherein the first indicator and the second indicator are light-emitting diodes.
